(19) United States
(12) Patent Application Publication
(10) Pub. No.: US 2024/0319574 A1
(43) Pub. Date: Sep. 26, 2024

(54) ADJUSTABLE LENS APERTURE ELEMENT IN A PROJECTION LENS

(71) Applicant: IMAX Corporation, Mississauga (CA)

(72) Inventors: Steven Charles Read, Mississauga (CA); Paul Constantinou, Burlington (CA)

(21) Appl. No.: 18/578,767

(22) PCT Filed: Jul. 15, 2022
(86) PCT No.: PCT/IB2022/056555

§ 371 Date: Jan. 12, 2024

Related U.S. Application Data
(60) Provisional application No. 63/222,753, filed on Jul. 16, 2021.

(51) Int. Cl. G03B 21/20

(52) U.S. Cl. CPC G03B 21/2053

(57) ABSTRACT

Image contrast of a projected image on a screen can be adjusted by configuring a lens aperture element in a projector. A projector can be set in a theatre to emit projected light representing the projected image onto the screen. The projected image can be projected onto the screen in the theatre such that a light level of the projected light is at a target light level. The lens aperture element in a projection lens of the projector can be configured to change an image contrast of the projected image. In response to inserting the lens aperture element, a setting for a light emitter in the projector can be adjusted such that the light level of the projected light is at the target light level.

### CROSS REFERENCE TO RELATED APPLICATION

This claims priority to U.S. Provisional Application No. 63/222,752, titled “Adjustable Lens Aperture Element in a Projection Lens” and filed Jul. 16, 2021, the entirety of which is incorporated herein by reference.

### TECHNICAL FIELD

The present disclosure relates generally to a theatre projector and, particularly but non-exclusively, to a projection lens for a theatre projector.

### BACKGROUND

Cinema theatres are increasingly using laser projection systems that have a laser light source to achieve improved displayed image quality and brighter light levels. Theatre screens for displaying projected images may vary in size, and thus the required lumens to achieve targeted light levels and image contrast for projected images onto the screens may vary. For example, a projector may have certain lumen capacity for projecting light onto a large screen. If the projector is used for projecting light onto a small screen, the light levels may be too high and the projected image may be too bright.

Removing, adding, and reconfiguring lens elements in a projection lens of the projector may adjust light levels. But, a significant inventory of lens elements may be required to accommodate the different target light levels for different screens, which may increase expenses. It may be difficult or time consuming to reconfigure the lens elements in a theatre environment.

The amount of light required to illuminate a cinema screen can be significant. The cinema lens design can ensure that glass types and coatings are chosen that have low thermal absorption so that the sharpness of the image is not degraded by thermal effects including thermal lensing. In addition, apertures throughout the cinema lens, including the pupil, can be designed to only absorb light that may otherwise degrade the image quality. Care should be taken, such as by using cinema lenses designed with fixed apertures, to ensure that this absorption does not cause thermal effects that may degrade image quality, lead to permanent degradation of the lens, or create a hardware failure concern. Fixed aperture designs can be difficult to modify to address changing theatre conditions or otherwise.

### BRIEF DESCRIPTION OF THE DRAWINGS

FIG. 1 is a side view of a theatre environment according to one example of the present disclosure

FIG. 2 is a block diagram of the projector according to one example of the present disclosure.

FIG. 3 is a side view of a projection lens in a projector, such as the projector depicted in FIG. 2, according to one example of the present disclosure.

FIG. 4 is a flowchart of a process for determining a change to a lens aperture element in a projector according to one example of the present disclosure.

FIG. 5 is a flowchart of a process for determining an aperture setting of a lens aperture element in a projector according to one example of the present disclosure.

FIG. 6 is a flowchart of a process for setting a projector to emit projected light such that the projected light reflecting off of a screen has a target light level, according to one example of the present disclosure.

### DETAILED DESCRIPTION

Certain aspects, features, and examples of the present disclosure relate to modifying image contrast of a projected image on a screen by changing or configuring a lens aperture element in a projector, such as projectors used in commercial cinemas that have high light output power levels. Configuring a lens aperture element in a projector can include installing a lens aperture element or reconfiguring an existing lens aperture element to modify performance of the existing lens aperture element. The projector can be a laser projector that can project light, including the projected image, towards the screen in a theatre. The projected light may reflect off the screen at a certain light level. The projector may include a projection lens comprising multiple lens elements. One of the multiple lens elements may be a lens aperture element having an opening that can be configured in the field such that the lens aperture element has a different opening size or shape. The projection lens can have a lens aperture element that is replaceable with another lens aperture element with a different size opening or with a lens aperture element that can allow the opening size to be adjusted. Additionally or alternatively, the projection lens can be configured with a lens aperture element in which the opening is adjustable. The size of the opening may be changed to reduce the amount of projected light that passes through the projection lens. Rather than having a lens element positioned within an illumination system or any portion of the light path within the projector, the lens aperture element may be inserted into the projection lens at a position that is a pupil, or any conjugate plane to the pupil. Configuring an aperture size of the lens aperture element positioned at the pupil may evenly lower the light level of projected light reflecting off of the screen without negatively impacting the image contrast of a projected image on the screen. This may be achieved by controlling the angular extent of the projected light passing through the projection lens. For example, modifying or adjusting the opening size of an appropriately positioned lens aperture element can allow the f number of the projected light passing through the projection lens to be changed. In some examples, changing the lens aperture element positioned at the pupil may improve the image contrast of the projected image on the screen. The examples provided will refer to a lens aperture that can be adjusted, where the term adjusted also refers to include an adjustment made by means of replacing a lens element with another lens element with a different aperture size or shape, or an adjustment being made by a mechanical means to change the aperture size or shape, or a mechanical means with a controlling device, or by means of replacing internal parts of the lens element to achieve a different aperture size or shape.

The lens aperture element may have an aperture with a particular size and shape. The particular size and shape may correspond to a particular reduction of a light level through light loss. The size and shape of the aperture may be fixed or variable and may be designed to optimize the increase in contrast of the projector for a given light loss. In some examples, adjusting the lens aperture element to change the light level may include removing a first lens aperture element with a first aperture causing a first light loss from a projection lens and replacing it with a second lens aperture element having a second aperture with a different size and shape of aperture to cause a second light loss that is different from the first light loss. Alternatively, the lens aperture element may have an aperture setting that can adjust the size, position, or shape of the aperture.

The lens aperture element may be adjusted in conjunction with adjustments to the light power of a light emitter in the projector, such that the light level of the reflected light meets a target light level. For example, during a theatre design phase, a system may determine a setting for the projector to emit projected light that will reflect light off of the screen at the target light level. The setting may be based on various theatre specifications, such as theatre size, screen size, screen reflectivity, distance between the projector and the screen, variable aperture sizes of potential lens aperture elements to be inserted into the projector, etc. The setting for the projector may include an aperture setting for adjusting the aperture shape or size of the lens aperture element. The setting for the projector may also include a light power setting for a light emitter in the projector. For example, the light emitter may be capable of emitting projected light at 50,000 lumens, and the target light level for reflected light may only require 30,000 lumens. The system may determine that the setting of the projector includes the light emitter emitting projected light at 40,000 lumens and the lens aperture element with an aperture of a certain size to be inserted into the projection lens. The light emitter power may be reduced from a capacity of 40,000 lumens to meet the target light level of 30,000 lumens. The capacity of the light emitter power to be increased over time may then be used to overcome light loss due to various theatre conditions.

In some examples, the projector may include a light controller for measuring a light level of projected light reflected by the screen and determining an adjustment to the aperture lens element and the light emitter so that the projector can emit light that reflects off of the screen at a target light level. The light emitter may be a solid-state light source, which may include lasers and light emitting diodes (“LEDs”). The projector may include illumination optics to direct light from the light emitters to illuminate an image modulator that may be based on DLP, LCOS or LCD technology. The projector may include imaging optics to direct the light from the image modulator to form an image on the screen. The target light level may include a target brightness and a target color. Adjusting the aperture setting of the lens aperture element may adjust the brightness of the projected light so that the projected light may be reflected at the target brightness.

In some examples, the projector may be configured to project light in a two-dimensional (“2D”) mode onto the screen. The projector may also be configured to project light in a three-dimensional (“3D”) mode onto the screen. The target brightness may differ between the modes and the aperture setting may be adjusted accordingly. For example, projectors may require a higher brightness when displaying 3D projected images on a screen versus 2D images.

In some examples, the lens aperture element may be coated black to avoid back-reflections and scattering of the projected light, which may degrade the optical integrity of the lens elements. In one example, the coating on the lens aperture element may be able to withstand up to 10 W/cm² of constant RGB laser illumination.

Because the lens aperture element may be easily and quickly adjusted or swapped within the projection lens, further adjustments to the lens aperture element for fine-tuning the light level may be made after the projector is installed in a theatre environment. Although projector settings for the light emitter and lens aperture element may have been previously determined, conditions in the theatre environment may require further adjustments. For example, screens, lenses, and other theatre components may experience degradation over time, causing the light level of reflected light to decrease. The light controller may determine adjustments to the light emitter and the lens aperture element to account for the loss of reflected light.

In some examples, the lens aperture element may be adjusted without the use of specialized tools. The lens aperture element may be adjusted in a theatre environment that may not be a clean room environment, and may be performed by a theatre technician. After removal of the projection lens from the projector, the adjustment to the lens aperture element may be quickly performed. In one example, the adjustment may be completed within five minutes. In some examples, the aperture setting may be continuously adjustable while the projector is projecting light onto the screen, without requiring removal of the lens aperture element from the projection lens.

Determining an adjustment to the lens aperture element in order to emit at a target light level for a particular theatre environment may depend on various factors, such as screen characteristics. This can include the type, width, height, curvature, and tilt of a screen in the theatre environment. In addition, the screen may be designed to direct light preferentially to the seating deck within the auditorium. The bidirectional reflectance distribution function (BRDF) of such a screen can be modeled and may be used to determine the resulting brightness at any location within the auditorium.

Other considerations for determining the adjustment to the lens aperture element may include a position of the projector relative to the screen, a focal length of the projection lens, the distortion characteristics of the lens and the projector tilt and lens offsets used to direct light to the screen. In addition, the projection modes such as 2D or 3D modes along with targeted brightness for these two modes of projection may be required to determine an adjustment to the lens aperture element. In some examples, determining adjustments may be based on degradation of components in the theatre environment. Detailed models of degradation mechanisms may be used to determine the appropriate aperture to use over extended periods of time. All the above may be used at the time the theatre is designed to predict the required aperture to optimize contrast while maintaining targeted light levels. In addition, the designer may use this information at design time to make adjustments to other parameters of the theatre design to improve the overall system performance.

Determining an adjustment to an aperture setting of an aperture lens element may be based on meeting light requirements for a projected image on a screen. For example, the aperture setting may be adjusted to cause the projected image to have a desired image quality or image contrast. In some examples, a calibration method may be used to calibrate the aperture setting for a specific theatre environment. The aperture setting may also be adjusted to reduce the light level to avoid exceeding a predetermined safe operating light level.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

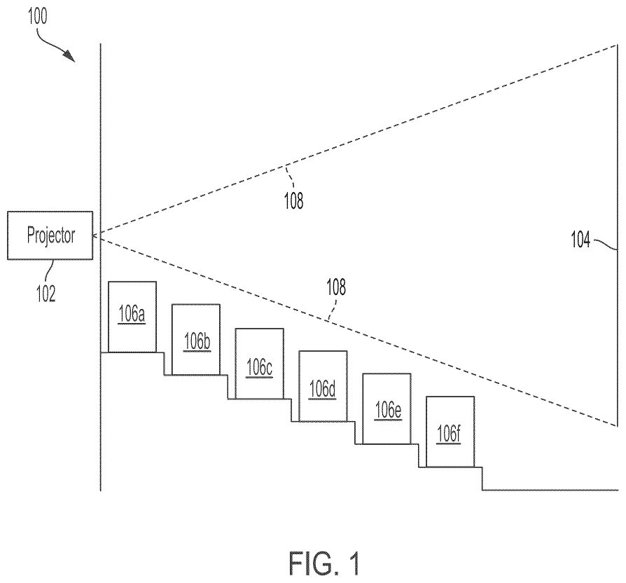

FIG. 1 is a side view of a theatre environment 100 according to one example of the present disclosure. The theatre environment 100 may include a projector 102, a screen 104, and seats 106a-f. The projector 102 may emit projected light 108 for displaying an image onto the screen 104. An audience may sit in the seats 106a-f to view the image on the screen 104. The seats 106a-f may be arranged on steps in the theatre environment 100, although in some examples the seats 106a-f may be arranged in different configurations.

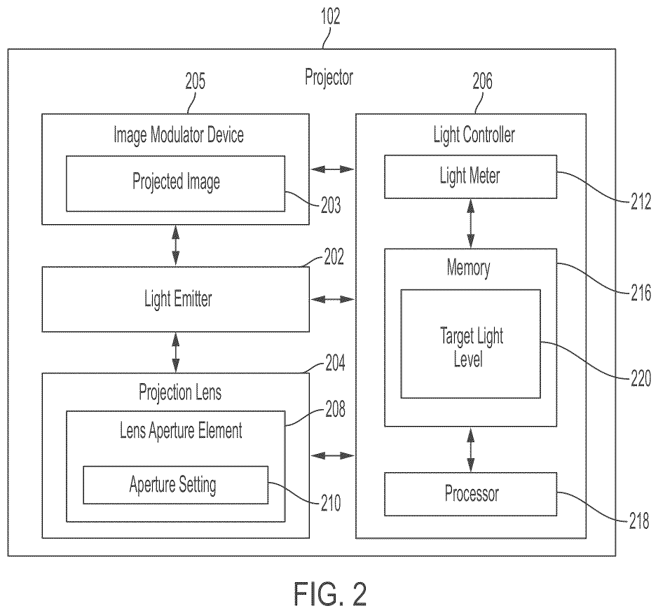

FIG. 2 is a block diagram of the projector 102 according to one example of the present disclosure. The components of FIG. 2 are discussed below with reference to the components discussed above in relation to FIG. 1. The projector 102 may include a light emitter 202, a projection lens 204, an image modulator device 205, and a light controller 206. The light controller 206 may control the light emitter 202 to emit projected light 108 that may pass through the image modulator device 205. The image modulator device 205 may be controlled by the light controller 206 to modulate the projected light 108 to create a projected image 203 that may pass through the projection lens 204 and onto the screen 104. The projection lens 204 may include a lens aperture element 208 that may be adjustable for causing an adjustment to a light level of the projected light 108 that reflects off of the screen 104. An example of an adjustment to the lens aperture element 208 may include adjusting an aperture size of the lens aperture element 208. Another example of an adjustment may include replacing the lens aperture element 208 with a different lens aperture element. In some examples, such as the one depicted in FIG. 2, the lens aperture element 208 may include an aperture setting 210 that may be adjusted to change the aperture in the lens aperture element 208. Examples of an aperture setting 210 may include an adjustable iris mechanism or an electronic aperture mask. The light controller 206 may also control the light emitter 202 and image modulator device 205 to adjust the light level of the reflected projected light 108.

The light controller 206 may include a light meter 212 that may be communicatively coupled to a memory 216. The memory 216 may also be communicatively coupled to a processor 218. The light meter 212 may measure and transmit a light level of the projected light 108 reflected off of the screen 104 to the memory 216. The memory 216 may include a target light level 220. The target light level 220 may be predetermined, or may be calculated by the processor 218. The projector 102 may adjust the lens aperture element 208, the image modulator device 205, and the light emitter 202 to project light at the target light level 220 and at a desired image contrast for the projected image 203 on the screen 104.

In some examples, the light emitter 202 may include RGB lasers (not pictured) for emitting the projected light 108. The target light level 220 may include a target brightness and a target color. The target brightness and color of the reflected projected light 108 may vary depending on the theatre environment, and adjustments to the aperture setting 210 may adjust the projected light 108 emitting from the RGB lasers so that the reflected projected light 108 has a target brightness and a target color.

The processor 218 can include one processor or multiple processors. Non-limiting examples of the processor 218 include a Field-Programmable Gate Array (FPGA), an application-specific integrated circuit (ASIC), a microprocessor, etc. The processor 218 can execute instructions stored in the memory 216 to perform operations. The instructions may include processor-specific instructions generated by a compiler or an interpreter from code written in any suitable computer-programming language, such as C, C++, C#, etc.

The memory 216 can include one memory or multiple memories. The memory 216 can be non-volatile and may include any type of memory that retains stored information when powered off. Non-limiting examples of the memory 216 include electrically erasable and programmable read-only memory (EEPROM), flash memory, or any other type of non-volatile memory. At least some of the memory 216 can include a non-transitory computer-readable medium from which the processor 218 can read instructions. A computer-readable medium can include electronic, optical, magnetic, or other storage devices capable of providing the processor 218 with computer-readable instructions or other program code. Non-limiting examples of a computer-readable medium include magnetic disk(s), memory chip(s), ROM, random-access memory (RAM), an ASIC, a configured processor, optical storage, or any other medium from which a computer processor can read the instructions.

In some examples, the light controller 206 can use the processor 218, and the processor can execute the instructions to perform operations. For example, the projector 102 may emit projected light 108 that may be reflected off of the screen 104 at a first light level. The light controller 206 may use the light meter 212 to measure the first light level. The light controller 206 may determine a difference between the first light level and the target light level 220. The light controller 206 may determine an adjustment to the lens aperture element 208 and the light emitter 202 based on the difference between the light levels. In some examples, the light controller 206 may determine an adjustment to the lens aperture element 208 and the light emitter 202 based on elements affecting the reflected light level such as screen characteristics, aspect ratio of the projected image 203, optical degradation of the lens aperture element 208, light reduction of a projection light source in the projector 102, light reduction received by the projection lens 204, light reduction from screen degradation, color stability of the projector 102, or brightness stability of the projector 102. After the lens aperture element 208 is adjusted, the projector 102 may emit projected light 108 that is reflected at the target light level 220.

In some examples, the light controller 206 may log measurements taken by the light meter 212. The light controller 206 may transmit the measurements out of the projector 102, such as to a service center or centralized cloud storage location. A theatre technician in the service center may monitor trends in the measurements for determining adjustments to the lens aperture element 208.

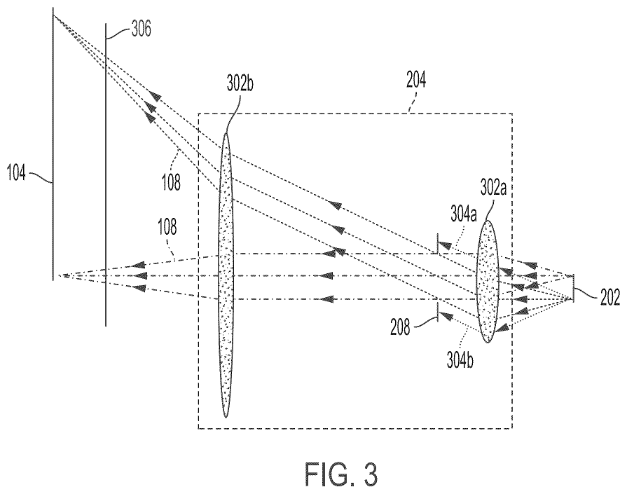

FIG. 3 is a side view of a projection lens 204 in a projector, such as the projector 102 depicted in FIG. 2, according to one example of the present disclosure. The projection lens 204 includes lens elements 302a-b. The projection lens 204 may include fewer or additional lens elements than the number of lens elements 302 depicted. In some examples, a projection lens 204 may include between 10 and 15 lens elements 302. An image modulator device 205, such as a DMD array which is illuminated by an RGB laser assembly (not shown), may emit projected light 108 that may pass through the lens elements 302a-b out of the projection lens 204 to be projected onto a screen 104.

A lens aperture element 208 may be positioned among the lens elements 302a-b at a position known as the pupil. The pupil may be the position in the projection lens 204 where an angle a ray makes at the pupil determines where the projected light 108 emitted by the projector 102 may hit the screen 104. The position of the pupil may depend on the number, type, and positioning of the lens elements 302a-b. Positioning the lens aperture element 208 at the pupil may improve an image contrast of a projected image 203 without decreasing an image quality of the projected image 203 by uniformly eliminating larger angle rays 304a-b from the image modulator device 205 to lower the light level. Image contrast may depend on the light level and a noise light level. The noise light level may include noise due to non-zero off-state light from an image modulator device 205 in the projector 102, bulk scattering from lens elements 302a-b, surface scattering from lens elements 302a-b, and reflections from lens elements 302a-b due to limits of anti-reflection coatings. The lens aperture element 208 may block larger angle rays from the image modulator device 205, which may reduce the noise light level more than the light level of the projected light 108, thus increasing the image contrast.

In some examples, optical element 306 can be positioned in the path of projected light 108. The projected light 108 can pass through the optical element 306 after being projected through the projection lens 204. The optical element 306 can be positioned in the path of projected light 108. For example, the optical element 306 may be positioned between the projection lens 204 and the screen 104. In some examples, the optical element 306 can be a linear or circular polarizer. Examples of linear or circular polarizers may include 3D encoders that can encode the projected light 108. The optical element 306 can also be positioned in the path of projected light 108 that is reflected by the screen 104 such as optical elements associated with 3D glasses that can be worn by a viewer of the projected image on the screen 104.

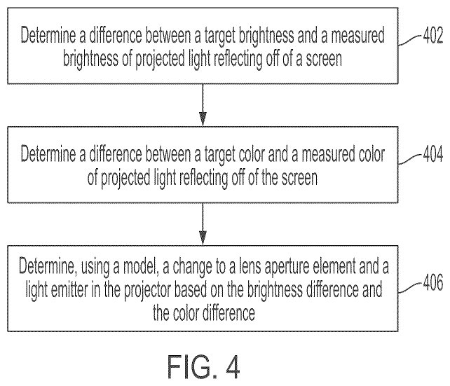

FIG. 4 is a flowchart of a process for determining a change to a lens aperture element 208 in a projector 102 according to one example of the present disclosure. Other examples can include more steps, fewer steps, different steps, or a different order of the steps than is shown in FIG. 4. The steps of FIG. 4 are discussed below with reference to the components discussed above in relation to FIG. 2.

At block 402, a light controller 206 in the projector 102 determines a difference between a target light brightness and a measured brightness of projected light 108. As depicted in FIG. 3, in some examples the projected light 108 can be projected light reflecting off of a screen 104. In other examples, the projected light 108 can come directly from the projection lens 204 towards the screen 104. In further examples, the projected light 108 can be light incident on the screen 104. The measured brightness of projected light 108 can be a measurement of the light coming directly from the projection lens 204 towards a screen 104, a measurement of the light incident on a screen 104, a measurement of the light reflecting off of a screen 104, or a combination thereof. The measured brightness may be measured by a light meter 212 in the light controller 206. In some examples, the measured brightness of the projected light 108 may be measured through the optical element 306.

At block 404, the light controller 206 determines a difference between a target color and a measured color. The measured color may be measured by the light meter 212. In some examples where a light emitter 202 in the projector 102 is an RGB laser assembly, the target color may include target colors for the reflected projected light emitted from each of the red, green, and blue lasers.

At block 406, the light controller 206 determines, using a model, a change to a lens aperture element 208 and a light emitter 202 in the projector 102 based on the brightness difference and the color difference. The model may determine a change to the lens aperture element 208 and the light emitter 202 that allows for the projected light 108 reflecting off the screen 104 to have the target brightness and the target color. In some examples, it may be difficult to configure the projector 102 such that the projected light 108 reflected off the screen 104 reaches both the target brightness and the target color. Therefore, the model may determine a change to the lens aperture element that allows for the projected light 108 to have a brightness and color that is closer to the target brightness and target color, respectively, than the measured brightness and measured color. In some examples, the model may be included in the memory 216 of the light controller 206. Alternatively, the model may be included in a memory of a computing device external to the projector 102. The light controller 206 may transmit the brightness difference and the color difference to the external computing device. The external computing device may determine a change to the lens aperture element 208.

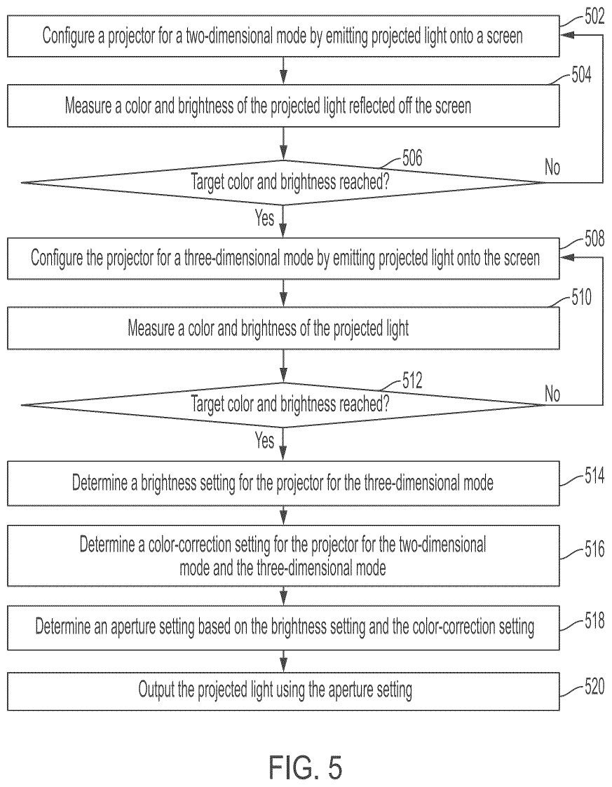

FIG. 5 is a flowchart of a process for determining an aperture setting 210 of a lens aperture element 208 in a projector 102 according to one example of the present disclosure. Other examples can include more steps, fewer steps, different steps, or a different order of the steps than is shown in FIG. 5. The steps of FIG. 5 are discussed below with reference to the steps discussed above in relation to FIG. 4.

At block 502, the projector 102 is configured for a 2D mode by emitting projected light 108 onto a screen 104. The projected light 108 may include a projected image 203. The projected light 108 that reflects off of the screen 104 may have a certain light level.

At block 504, a light controller 206 in the projector 102 measures the color and brightness of the certain light level using a light meter 212. In some examples, the light meter 212 may include a photometer for measuring the brightness of the projected light 108 that reflects off of the screen 104. In some examples where the projector 102 includes an RGB laser assembly, the measured color may include a measure of the red, green, and blue colors emitted by the lasers in the projector 102. The light meter 212 may include a colorimeter for measuring the color of the projected light 108 that reflects off of the screen 104.

At block 506, the light controller 206 determines if a target color and a target brightness have been reached with an allowance for system degradation. The light controller 206 can determine if the target color and target brightness have been reached by comparing the measured color to the target color, and comparing the measured brightness to the target brightness. If the target color and the target brightness have not been reached, the process continues to block 502 to reconfigure the projector 102 to emit the projected light 108 to have a different color and different brightness once reflected off of the screen 104 that may be closer to the target color and the target brightness. If the target color and the target brightness have been reached, the process continues to block 508.

At block 508, the projector 102 is configured for a 3D mode by emitting projected light 108 onto the screen 104. For example, the projected light 108 for the 3D mode may include left eye and right eye images. A viewer in the theatre environment 100 may wear glasses to assist in viewing the left eye and right eye images. The target brightness and the target color for the 3D mode may not be the same as a target brightness and a target color for the 2D mode. For example, projected light 108 reflected off of the screen 104 including left eye and right eye images in 3D mode may have a lower brightness than projected light in a 2D mode. The target color for the left eye and right eye images in projected light 108 reflected off of the screen 104 for a 3D mode may be different compared to the target color of projected light 108 for a 2D mode.

At block 510, the light controller 206 measures a color and brightness of the projected light 108 reflected off the screen 104 using the light meter 212.

At block 512, the light controller 206 determines if a target color and a target brightness have been reached with an allowance for system degradation. The light controller 206 can determine if the target color and target brightness have been reached by comparing the measured color to the target color, and comparing the measured brightness to the target brightness. If the target color and the target brightness have not been reached, the process continues to block 508 to reconfigure the projector 102 to emit the projected light 108 to have a different color and different brightness once reflected off of the screen 104 that may be closer to the target color and target brightness. If the target color and the target brightness have been reached, the process continues to block 514.

At block 514, the light controller 206 determines a brightness setting for the projector 102 for the 3D mode. In some examples, determining the brightness setting may be based on a difference between the measured brightness and the target brightness for the 3D mode. Determining the brightness setting may also be based on other factors in the theatre environment 100 that may affect the brightness of the projected light 108, such as a distance between the projector 102 and the screen 104, the BRDF of the screen 104, ambient light, etc. The brightness setting may cause the projector 102 to project light that reflects off of the screen 104 at the target brightness.

At block 516, the light controller 206 determines a color-correction setting for the projector 102 for the 2D mode and the 3D mode. The color-correction setting for the 2D mode may differ from the color-correction setting for the 3D mode. In the example where the projector 102 includes an RGB laser assembly, the color-correction setting may include a color-correction setting for the red, green, and blue lasers. In some examples, determining the color-correction setting for the 2D mode and the 3D mode may be based on a difference between the measured color and the target color for the 2D mode or the 3D mode. Determining the color-correction setting may also be based on other factors in the theatre environment 100 that may affect the color of the projected light 108, such as laser degradation, screen degradation, optical integrity of the projection lens 204, etc. The color-correction setting may cause the projector 102 to project light that reflects off of the screen 104 at the target color.

At block 518, the light controller 206 determines an adjustment to an aperture setting 210 of the lens aperture element 208 for the 2D mode and the 3D mode based on the brightness setting and the color-correction setting. For example, if the brightness setting included decreasing the emitted light of the projector below a level needed to maintain that light over time due to degradation, the adjustment may include adjusting the aperture setting 210 to decrease a size of an aperture in the lens aperture element 208. The adjustment to the aperture setting 210 for the 2D mode may differ from the adjustment to the aperture setting 210 for the 3D mode.

At block 520, the projector 102 outputs the projected light 108 using the adjusted aperture setting 210. If the projector 102 is outputting the projected light 108 in the 2D mode, the projector 102 may use the adjustment to the aperture setting 210 determined for the 2D mode. If the projector 102 is outputting the projected light 108 in the 3D mode, the projector 102 may use the adjustment to the aperture setting 210 determined for the 3D mode. The projected light 108 reflecting off of the screen 104 may have the target brightness and target color for the 2D mode or the 3D mode.

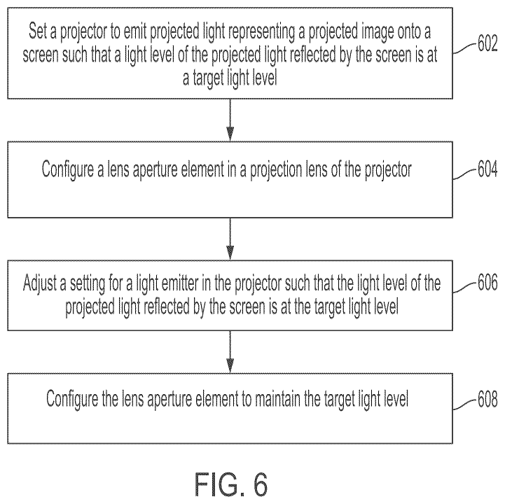

FIG. 6 is a flowchart of a process for setting a projector 102 to emit projected light 108 such that the projected light 108 reflecting off of a screen 104 has a target light level 220, according to one example of the present disclosure. Other examples can include more steps, fewer steps, different steps, or a different order of the steps than is shown in FIG. 6. The steps of FIG. 6 are discussed below with reference to the components discussed above in relation to FIGS. 1-3.

At block 602, set, by a theatre technician, a projector 102 in a theatre environment 100 to emit projected light 108 representing a projected image 203 onto a screen 104 such that a light level of the projected light 108 reflected by the screen 104 is at a target light level 220. The projector settings may be previously determined in a design phase of the theatre environment 100. The projector 102 settings may include settings for a projection lens 204, a light emitter 202 emitting the projected light 108, an image modulator device 205 creating the projected image 203, and any other settings to configure the projector 102.

At block 604, configure, by the theatre technician, a lens aperture element 208 in a projection lens 204 of the projector 102. The lens aperture element 208 may be inserted into a location in the projection lens 204 that is the pupil. The lens aperture element 208 may be configured by being reconfigured through adjustment while in the projection lens 204. For example, a size or shape of an aperture in the lens aperture element 208 may be adjusted by a mechanical tool. Configured lens aperture element 208 may reduce some of the larger angle rays 304a-b of the projected light 108, thus reducing a light level of the projected light 108 reflected by the screen 104.

At block 606, adjust, by the theatre technician, a setting for a light emitter 202 in the projector 102 such that the light level of the projected light 108 reflected by the screen 104 is at the target light level 220. The setting may include increasing a light output emitted by the light emitter 202 to account for decreased projected light 108 reflected by the screen 104 due to the configured lens aperture element 208 blocking some of the projected light 108.

Optionally, at block 608 the process can include configuring, by a theatre technician, the lens aperture element 208 to maintain the target light level 220. The lens aperture element 208 may be configured when the setting for the light emitter 202 has reached a maximum light output level. The maximum light output level for the light emitter 202 may decrease over time. For example, when the light emitter 202 is new, a lower setting for the light emitter 202 may be used to reach the target light level 220. But, after a certain amount of time, the light emitter 202 may be increased to a maximum setting to cause the projected light 108 to reach the target light level 220. Therefore, the light emitter 202 when set to its maximum brightness level can maintain the target light level 220 for an extended length of time by configuring the lens aperture element 208. In one example, the lens aperture element 208 can be configured to block less projected light 108. Blocking less projected light 108 can reduce the image contrast by allowing more projected light 108 to be projected by the projection lens 204, allowing the projected light 108 to reach the target light level 220 without increasing the light emitter settings of the projector 102. This technique can be used to extend the life of the light emitter 202.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure. For instance, examples described herein can be combined together to yield still further examples.

1. A method comprising:
setting a projector in a theatre to emit projected light representing a projected image onto a screen in the theatre such that a light level of the projected light is at a target light level;
replacing a lens aperture element in a projection lens of the projector in the theatre to change an image contrast of the projected image; and
in response to replacing the lens aperture element, adjusting a setting for a light emitter in the projector such that the light level of the projected light is at the target light level.

2. The method of claim 1, further comprising adjusting the setting for the light emitter to a maximum output for the target light level, and
replacing the lens aperture element to maintain the target light level.

3. (canceled)

4. The method of claim 1, wherein the light level of the projected light is a level of projected light that is reflected off the screen.

5. The method of claim 1, wherein the light level of the projected light is a level of projected light that passes through an optical element that is external to the projection lens.

6. The method of claim 1, further comprising replacing the lens aperture element to change image contrast of the projected image.

7. The method of claim 1, wherein the lens aperture element is removable from the projection lens.

8. The method of claim 1, wherein replacing the lens aperture element includes replacing the lens aperture element with a lens element that has an adjustable aperture setting that is continuously adjustable during projection.

9. The method of claim 1, wherein the screen has a bidirectional reflectance distribution function that increases brightness from a location on the screen for at least one seat in an audience of the theatre.

10. The method of claim 1, wherein a first lens aperture element in a first projection lens has a first aperture with a first shape and a second lens aperture element in a second projection lens has a second aperture with a second shape, and wherein the first lens aperture element has a first light loss and the second lens aperture element has a second light loss, and wherein the first light loss is different from the second light loss based on a difference between the first shape and the second shape.

11. A projector configured to be positioned in a theatre, the projector comprising:
a light emitter configured to emit, toward a screen in the theatre, projected light that represents a projected image such that a light level of the projected light is at a target light level;
a light controller configured to:
determine a difference between the light level and the target light level;
determine a change to the light emitter based on the difference; and
determine a change to replacing a lens aperture element based on the difference; and
a projection lens that includes the lens aperture element that is replaceable.

12. The projector of claim 11, wherein the light level of the projected light is a level of projected light that is reflected off of the screen.

13. The projector of claim 11, wherein the light level of the projected light is a level of projected light that passes through an optical element that is external to the projection lens.

14. The projector of claim 11, wherein the lens aperture element is replacing to change image contrast of the projected image.

15. The projector of claim 11, wherein the lens aperture element is removable from the projection lens.

16. The projector of claim 11, wherein the lens aperture element that is replaceable has an aperture setting that is continuously adjustable during projection.

17. The projector of claim 11, wherein the screen has a bidirectional reflectance distribution function configured to increase brightness from a location on the screen for at least one seat in an audience of the theatre.

18. A method comprising:
determining a difference between a light level of projected light in a theatre and a target light level, the projected light being emitted by a projector in the theatre and representing a projected image;
determining an adjustment to a lens aperture element of a projection lens in the projector based on the difference between the light level and the target light level and to adjust image contrast of the projected image on a screen, wherein the lens aperture element is replaceable;
determining an adjustment to a light emitter in the projector based on the difference between the light level and the target light level; and
outputting the adjustment.

19. The method of claim 18, wherein the light level of the projected light is a level of projected light that is reflected off of the screen.

20. The method of claim 18, wherein the light level of the projected light is a level of projected light that passes through an optical element that is external to the projection lens.

21. The method of claim 18, wherein determining the adjustment to the lens aperture element includes determining the adjustment of a replaceable aperture element such that the projected light reflected by the screen is set to the target light level.

22. The method of claim 18, wherein the lens aperture element is removable from the projection lens.

23. The method of claim 18, wherein the lens aperture element that is replaceable has includes an aperture setting that is continuously adjustable during projection.

24. The method of claim 18, wherein the screen has a bidirectional reflectance distribution function that increases brightness from a location on the screen for at least one seat in an audience of the theatre.

25. The method of claim 18, wherein a first lens aperture element in a first projection lens has a first aperture with a first shape and a second lens aperture element in a second projection lens has a second aperture with a second shape, and wherein the first lens aperture element has a first light loss and the second lens aperture element has a second light loss, and wherein the first light loss is different from the second light loss based on the difference between the first shape and the second shape.

26. The method of claim 18, wherein determining the adjustment to the lens aperture element is based on a change of projected light reflected by the screen due to:
a size of the screen displaying the projected light;
an aspect ratio of the projected image;
optical degradation of the lens aperture element that is replaceable;
light reduction of a projection light source in the projector;
light reduction received by the projection lens;
light reduction from screen degradation;
color stability of the projector; and
brightness stability of the projector.

27. The method of claim 26, further comprising:
determining an adjustment to the replaceable aperture element based on:
light requirements of the projected image;
a calibration method for calibrating the replaceable aperture element; and
a predetermined safe operating light level of the projected light.

28. A light controller comprising:
a light meter configured to measure light levels of projected light in a theatre and that represents a projected image, the projected light being emitted from a projector in the theatre;
a processor; and
a non-transitory memory including instructions that are executable by the processor for causing the processor to:
receive, from the light meter, a first light level;
determine a difference between the first light level and a target light level;
determine an adjustment to a replaceable lens aperture element of a projection lens in the projector based on the difference between the first light level and the target light level and to adjust image contrast of the projected image on a screen in the theatre; and
output the adjustment of the replaceable lens aperture element.

29. The light controller of claim 28, wherein the light levels of the projected light are levels of projected light that are reflected off of the screen.

30. The light controller of claim 28, wherein the light levels of the projected light are levels of projected light that pass through an optical element that is external to the projection lens.

31. The light controller of claim 28, wherein the instructions are further executable by the processor for causing the processor to determine the adjustment to the replaceable lens aperture element such that the projected light reflected by the screen is set to the target light level.

32. The light controller of claim 28, wherein the replaceable lens aperture element is removable from the projection lens.

33. The light controller of claim 28, wherein the replaceable lens aperture element has an aperture setting that is continuously adjustable during projection.

34. The light controller of claim 28, wherein the screen has a bidirectional reflectance distribution function that increases brightness from a location on the screen for at least one seat in an audience of the theatre.

35. The light controller of claim 28, wherein a first lens aperture element in a first projection lens has a first aperture with a first shape and a second lens aperture element in a second projection lens has a second aperture with a second shape, and wherein the first lens aperture element has a first light loss and the second lens aperture element has a second light loss, and wherein the first light loss is different from the second light loss based on the difference between the first shape and the second shape.

36. The light controller of claim 28, wherein the instructions are further executable by the processor for causing the processor to determine the adjustment of the replaceable lens aperture element based on a change of projected light reflected by the screen due to:
a size of the screen displaying the projected light;
an aspect ratio of the projected image;
optical degradation of the replaceable lens aperture element;
light reduction of a projection light source in the projector;
light reduction received by the projection lens;
light reduction from screen degradation;
color stability of the projector; and
brightness stability of the projector.

37. The light controller of claim 36, wherein the instructions are further executable by the processor for causing the processor to determine an adjustment of the replaceable lens aperture element based on:
light requirements of the projected image;
a calibration method for calibrating the replaceable lens aperture element; and
a predetermined safe operating light level of the projected light.

38. A system comprising:
a processor; and
a non-transitory computer-readable memory including instructions that are executable by the processor for causing the processor to:
receive theatre specifications for a theatre;
determine, based on the theatre specifications, a light level for a projector; and
determine, based on the light level, a replaceable lens aperture element in a projection lens of the projector to adjust image contrast of a projected image in projected light emitted by the projector.

39. The system of claim 38, wherein the theatre specifications comprise:
size of a screen in a theatre;
reflectivity of the screen;
maximum light level for the projector; and
distance between the screen and the projector.

40. The system of claim 38, wherein the projector is adapted to produce a target light level of projected light that reflects off of a screen in the theatre.

41. The system of claim 38, wherein the instructions are further executable by the processor for causing the processor to determine, based on the light level, a setting for a light emitter in the projector.

42. The method of claim 1, wherein the lens aperture element is removable in a theatre environment.

43. The projector of claim 11, wherein the lens aperture element is removable in a theatre environment.

44. The method of claim 22, wherein the lens aperture element is removable in a theatre environment.

45. The light controller of claim 30, wherein the replaceable lens aperture element is removable in a theatre environment.
